(19) United States
(12) Patent Application Publication
(10) Pub. No.: US 2012/0032029 A1
(43) Pub. Date: Feb. 9, 2012

(54) SPACE LAUNCH VEHICLE USING MAGNETIC LEVITATION

(76) Inventor: Fernando Dee La Peña Llaca, Mexico (MX)

(21) Appl. No.: 13/265,218

(22) PCT Filed: Feb. 12, 2010
(86) PCT No.: PCT/MX10/00011

§ 371 Date: Oct. 19, 2011

(51) Int. Cl. B64G 1/40

(52) U.S. Cl. 244/171.3

(57) ABSTRACT

A space launch vehicle used for launching spacecraft uses a magnetic levitation system in order to reduce friction since the vehicle floats above rails. The system uses magnetic coils to propel and move the vehicle away from the quiescent point thereof. The invention facilitates the launch of a spacecraft, the time at which most fuel is required, so that the spacecraft is subsequently propelled by its own means. This method saves a large amount of fuel, which adds weight to the vehicle, such that saved weight can be used for payload. The system has the additional advantage of being reusable, as well as being modular to adapt to various types of spacecraft. Furthermore, the rocket or craft is launched at an angle of 57 degrees, dispensing with the need to change the angle of the craft from 90 to 57 degrees, as is currently the case, thus also saving fuel.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to the field of space launch vehicles. More particularly, the present invention relates to a space launch vehicle using magnetic levitation.

2. Description of Related Art Including Information Disclosed Under 37 CFR 1.97 and 37 CFR 1.98.

For decades the only viable way of sending a vehicle into space has been through rockets. These space rockets require a large amount of fuel to take off from the Earth's atmosphere, thus limiting the load that they can take into space, since a major portion of the rocket's weight is fuel.

A very significant part of this fuel is used up at the beginning, since a large amount of fuel is required to lift off the ship from its resting point.

For example, among rockets that consume solid fuel and liquid fuel (LH2-LOX), we can mention the Atlas V rocket, used to send satellites into space; they weigh 546,700 Kg, but can only carry to a geo-stationary orbit a maximum weight of 13,000 Kg. It can only carry about 2.4% of the rocket's weight as service weight.

Rockets such as Delta IV, weigh 733,400 Kg, and can carry to a geo-stationary orbit a maximum weight of 10,843 Kg, only about 1.48% of its weight.

Even the new generation of Ares rocket, such as Ares V, with a weight of 3,311,224 Kg, can carry to the moon a maximum service load of 53,070 Kg, approximately 1.6% of its weight.

So it is that current designs require, in summary, a large amount of fuel, thus limiting to a great extent the service load capacity that, in the most optimistic of cases, attain 2.4% of the weight. In order to do away with these and other problems, they thought about the development of this launcher.

### BRIEF DESCRIPTION OF THE DRAWINGS

The characteristic details of this space launch vehicle using magnetic levitation are shown in the following description and on the attached drawings.

This description contains a total of 8 figures, which I now describe below:

FIG. 1 is a view of the magnetic levitation track of the space launch vehicle, which in (No. 1) of this figure shows the rails, in (No. 2) the levitation and orientation coil is located, in (No. 3) is the propulsion coil and (No. 4) shows the support guide for the wheel.

FIG. 2 is an approximation of the magnetic levitation system, both of the track and the vehicle, which in (No. 1) of this figure shows the vehicle orientation magnet is found, (No. 2) shows the track rail, (No. 3) depicts the track stator, (No. 4) shows the vehicle support magnet, and finally (No. 5) shows the body of the vehicle.

FIG. 3 is a front view of the magnetic levitation system, both of the track and vehicle; (No. 1) of this figure contains the vehicle body, while (No. 2) shows the track rail.

FIG. 4 is a view of the vehicle used to carry the rocket or spacecraft, which in (No. 1) it shows the body, in (No. 2) the pad where the rocket or spacecraft is transported on the magnetic levitation system; (No. 3) shows 4 parachutes of the vehicle, and lastly (No. 4) depicts the interconnection system between vehicles.

FIG. 5 is another view of the vehicle, which shows (No. 1) the vehicle air brakes.

FIG. 6 is a graph of the track designed for the vehicle to take off, which in (No. 1) shows the scale of each chart, which is 100 meters wide by 100 meters high; (No. 2) shows the point where the pad changes its angle of inclination angle from zero degrees until it reaches 57 degrees; (No. 3) shows the point where the angle already reached 57 degrees of inclination necessary for takeoff, and (No. 4) shows the takeoff point, where the spacecraft or rocket separates from the vehicle.

FIG. 7 is another view of the magnetic levitation track, where (No. 1) shows the vehicle starting point and (No. 2) shows the takeoff point where the spacecraft of rocket separates from the vehicle.

FIG. 8 is another view of the vehicle, which in (No. 1) shows the air brake, and in (No. 2) it shows the pad or mat where the rocket or spacecraft will be located.

### DETAILED DESCRIPTION OF THE INVENTION

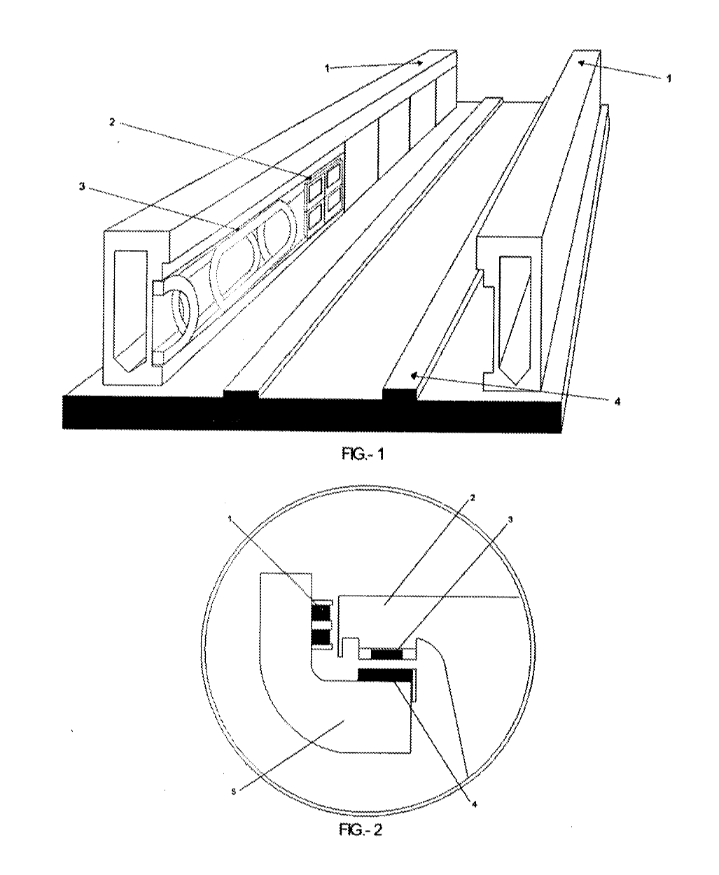

In reference to said figures, we can describe a magnetic levitation system on which the magnetic coil of the track according to FIG. 1 repels the vehicle magnets according to FIG. 2, which allows the vehicle to levitate as much as 10 centimeters from the rails, since there is no friction.

Once the vehicle levitates, power is supplied to the coils on the track to create magnetic fields that pull and push the vehicle along the track for the vehicle to move through it. Thus the electrical current that comes into the track coils is alternated to change the polarity of the magnetized coils so that the magnetic field on the vehicle front will pull it forward while the field in the rear will give it more thrust.

According to FIG. 4, the vehicle is 25 meters long, therefore if you wish to interconnect more vehicles, it can be done via an interconnection module described in that figure, to cover the necessary length of the spacecraft or rocket.

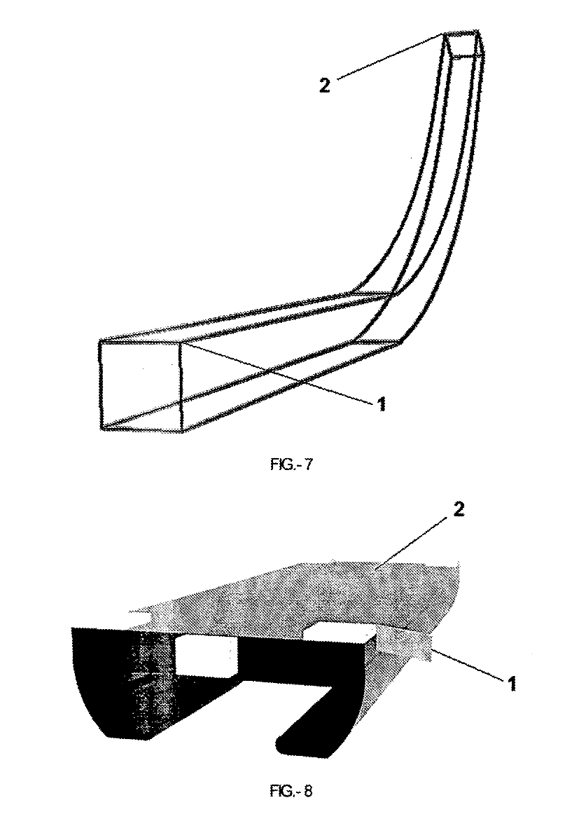

The spacecraft or rocket is placed on the vehicle mat or pad, therefore when it starts up with the rocket from the start of the track as shown in FIG. 7, it will not be driven by magnetic field, it will have no friction.

On the track, according to FIG. 6, the vehicle starts driven by magnetic fields, thus avoiding the use of fuel by the rocket to take off from its resting point; the vehicle runs through the track at zero degrees of inclination. When the track starts to incline, the rocket or spacecraft starts up its engines, so that when it arrives at the end of the track, it will have sufficient speed to continue lifting up on its own.

The track will release the rocket when it reaches a height of 800 meters and there is an angle of 57 degrees—the desired angle to reach places such as the International Space Station (ISS), the rocket will be secured to the vehicle by bolts with explosives, such as those used on the space shuttle to secure it the launching pad, which when the first vehicle arrives at the maximum track height released the rocket or the spacecraft so that it will run with its own engines.

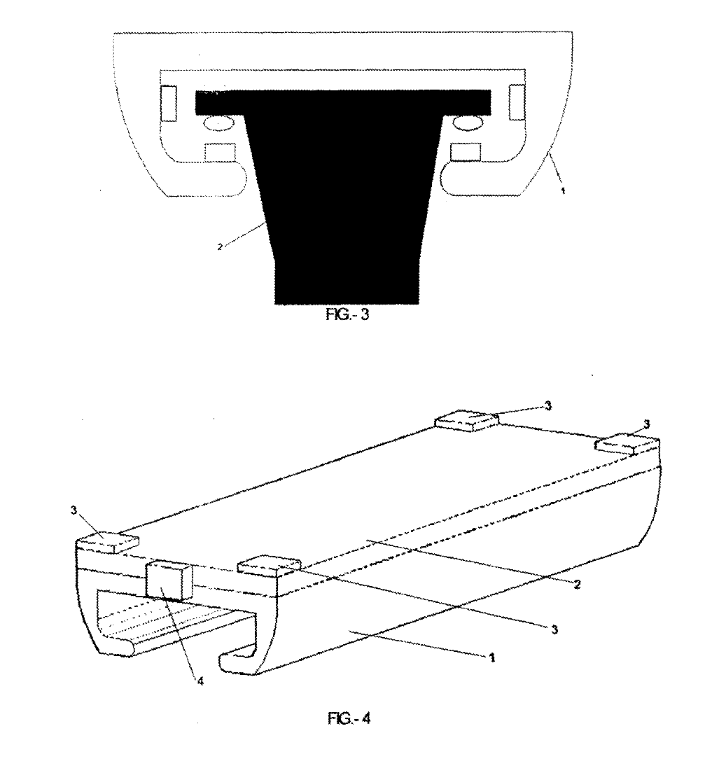

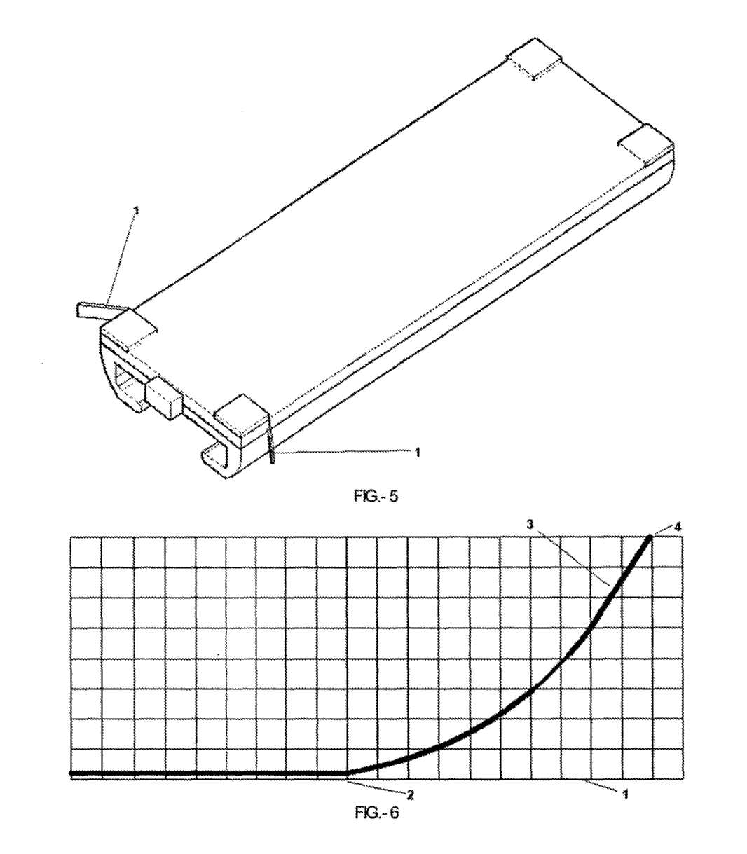

When the vehicle breaks off the spacecraft or rocket and at the end of the track, the rocket will shoot out, so that in order to reduce its speed, a vehicle air brake is used as the one described in FIG. 5, in order to reduce speed to subsequently open 4 parachutes according to FIG. 3, providing a smooth descent to use again the vehicle in another takeoff.

Thus, a magnetic levitation space launch vehicle is obtained with the following characteristics:

It has no friction, since this way a magnetic levitation space launch vehicle is obtained with the following characteristics:

a) It levitates on the track.

b) The spacecraft or rocket takes off from its resting point via magnetic levitation; therefore, this becomes a major fuel saving.

c) It is reusable.

d) The spacecraft or rocket shoots out at 57 degrees; therefore, it does not have to adjust its inclination as in the case of conventional rockets, which is also fuel savings.

e) It is modulable, since several vehicles can be interconnected in order to carry spacecrafts or rockets of different sizes.

In view of all of the above-stated, one can say that no space launch vehicle presently used has these characteristics.

1. A magnetic levitation space launch vehicle that is characterized by the magnetic levitation vehicle structure, which comprises a mat for the spacecraft, a vehicle interconnection system, air brakes and at least one parachute.

2. A magnetic levitation space launch vehicle that is characterized by the track structure, which is 1900 meters long and 800 meters high, with a launching angle of 57 degrees, which uses magnetic fields to make the vehicle levitate.
